(19) United States
(12) Patent Application Publication
(10) Pub. No.: US 2024/0328170 A1
(43) Pub. Date: Oct. 3, 2024

(54) CLADDING SYSTEM

(71) Applicant: VEEV GROUP, INC., San Mateo (CA)

(72) Inventors: Amit HALLER, Belmont, CA (US); Israel Jay KLEIN, Kfar Saba (IL)

(21) Appl. No.: 18/574,808

(22) PCT Filed: Jun. 28, 2022
(86) PCT No.: PCT/IL2022/050694

§ 371 Date: Dec. 28, 2023

Related U.S. Application Data
(60) Provisional application No. 63/215,681, filed on Jun. 28, 2021.

(51) Int. Cl. E04F 13/08; A01G 9/02; E04F 13/074

(52) U.S. Cl. CPC E04F 13/083; A01G 9/02; E04F 13/074

(57) ABSTRACT

A cladding system comprising: a framing structure configured to be fixedly mounted to a wall of a building, said framing structure having one or more designated locations for mounting a cladding module thereon; a utility infrastructure configured to be connected to the framing structure and establish a pathway for a utility resource, said pathway having a utility port for interfacing with a cladding module being disposed at one of said designated locations when said utility infrastructure is connected to said framing structure; and at least one first cladding module having a functional element, said at least one cladding module being configured to be mounted to the framing structure at any one of said designated locations, said functional element being configured for connecting to the utility port for establishing said pathway and for interfacing with said utility resource therethrough.

### TECHNOLOGICAL FIELD

The presently disclosed subject matter relates to cladding systems; particularly, the presently disclosed subject matter relates to modular cladding systems for walls, floors, roof of a building.

### BACKGROUND

There are inherent conflicts between the design aspirations of building architects and the needs for streamlined operational processes such as manufacturing, installation, maintenance, and supply chain aspects, especially for the external parts of the buildings and houses including building walls and the roof parts and landscape associated parts. At any time the architects request some new and unique design feature, this in response creates an extensive chain reaction effect which impacts all operational stages including completing the associated design work, manufacturing, installation, supply chains, lifetime support etc.

Some of the rain screening technologies (which have been in the building industry for more than 50 years) provide an exterior cladding solution which is aimed for rain drainage and thermal isolation. Their decorative value is limited by some color or texture variations of the external tiles. The tiles themselves are dimensioned according to the pre-assumption that the exterior cladding process is independent of the building construction and design, at least from a supplier perspective.

Therefore, it is required that the design and operational characteristics be decoupled as much as possible, thereby permitting both design flexibility and streamlined and simplified operations. Thus, there exists a need for an improved modular cladding system that supports the design requirements as well as specific functional (operational) requirements.

### GENERAL DESCRIPTION

The presently disclosed subject matter relates to a modular cladding system that supports both design flexibility and streamlined operational related processes for building exterior and interior locations including the building walls and the rooftops and landscape areas. The cladding system provides a plurality of cladding of different types that can be modularly mounted to the building using a same mounting system.

It is to be noted herein that for the purposes of this description, the cladding system, and components thereof, being configured to be mounted to a wall of the building is to be considered as including within its scope that the cladding system, and components thereof, is configured to be mounted to any other location such as roof, landscape, floor, etc. of the building.

According to a first aspect of the presently disclosed subject matter, there is provided a cladding system comprising: a framing structure configured to be fixedly mounted to a wall of a building, said framing structure having one or more designated locations for mounting a cladding module thereon; a utility infrastructure configured to be connected to the framing structure and establish a pathway for a utility resource, said pathway having a utility port for interfacing with a cladding module being disposed at one of said designated locations when said utility infrastructure is connected to said framing structure; and at least one first cladding module having a functional element, said at least one first cladding module being configured to be mounted to the framing structure at any one of said designated locations, said functional element being configured for connecting to the utility port for establishing said pathway and for interfacing with said utility resource therethrough.

The framing structure can comprise a plurality of struts configured to be assembled in the form of equally spaced rows and equally spaced columns, and to be fixedly mounted to the wall of the building.

The cladding system can further comprise a mounting system configured for mounting the at least one first cladding module to the framing structure.

The cladding system can further comprise at least one second cladding module, different from the first cladding module, configured to be mounted to the framing structure. The mounting system can be configured for mounting the at least one second cladding module to the framing structure. In some examples, the mounting system can be configured for enabling the first and the second cladding modules to be interchangeably mounted to the framing structure by the mounting system.

According to a second aspect of the presently disclosed subject matter, there is provided a cladding system comprising: a framing structure comprising a plurality of struts configured to be assembled in the form of equally spaced rows and equally spaced columns, and to be fixedly mounted to a wall of a building; at least one first cladding module configured to be mounted to the framing structure; at least one second cladding module, different from the first cladding module, configured to be mounted to the framing structure; and a mounting system configured for mounting each one of the first and the second cladding modules to the framing structure, wherein the mounting system is configured for enabling the first and the second cladding modules to be interchangeably mounted to the framing structure by the mounting system.

The cladding system can further comprise a utility infrastructure configured to be connected to the framing structure and establish a pathway for a utility resource to be interfaced with at least the at least one first cladding module.

The cladding system according to either of the first and the second aspects of the presently disclosed subject matters can optionally include one or more of the following features:
the utility infrastructure can be configured to be positioned at least partially in a gap between the framing structure and the wall of the building when the framing structure is mounted to the wall;
the at least one first cladding module can be a planter module and the functional element is a plant;
the pathway can constitute an irrigation path for water hose, and the utility can be a water outlet;
the at least one first cladding module can be a lighting panel and the functional element can be an illuminating element;
the pathway can constitute a path for electrical connections, and the utility port can be an electrical socket;
the framing structure can comprise a utility socket and the utility port can be connected to the utility socket;
the pathway can comprise a plurality of utility ports, each corresponding to one or more of the designated locations;
each of the plurality of ports can be configured to be accessed through a corresponding designated location of the one or more designated locations;
the framing structure can comprise a plurality of utility sockets and at least one of the plurality of utility ports can be connected to at least one of the plurality of utility sockets;
at least one of the plurality of utility ports can be configured to be open while at least another of the plurality of utility ports is closed;
the utility infrastructure can be at least partially integrated to the framing structure;
spaces between the rows and the columns can define the designated locations;
each of the designated locations can be defined by a space between a first number of adjacent rows and a second number of adjacent columns;
the utility infrastructure can be configured to pass through at least some of the plurality of struts when the framing structure is mounted to the wall;
the mounting system can comprise frame mounting sockets formed on the framing structure and connecting elements extending from the at least one cladding module and configured to be detachably connected to the frame mounting sockets;
the frame mounting sockets can be formed on the struts;
each of the struts can comprise a plurality of frame mounting sockets, each configured for selectively detachably connecting the connecting elements thereto;
the mounting system can further comprise module mounting sockets formed on the at least one first cladding module, wherein the connecting elements are configured to be detachably connected to the module mounting sockets;
a distance between the module mounting sockets can correspond to the distance between said columns and can be arranged according to a predetermined pattern;
the mounting system can be configured for mounting the at least one second cladding module to the framing structure; and
the mounting system can be configured for enabling the first and the second cladding modules to be interchangeably mounted to the framing structure by the mounting system.

### EMBODIMENTS

A more specific description is provided in the Detailed Description whilst the following are non-limiting examples of different embodiments of the presently disclosed subject matter:

1. A cladding system comprising:
a framing structure configured to be fixedly mounted to a wall of a building, said framing structure having one or more designated locations for mounting a cladding module thereon;
a utility infrastructure configured to be connected to the framing structure and establish a pathway for a utility resource, said pathway having a utility port for interfacing with a cladding module being disposed at one of said designated locations when said utility infrastructure is connected to said framing structure; and
at least one first cladding module having a functional element, said at least one cladding module being configured to be mounted to the framing structure at any one of said designated locations, said functional element being configured for connecting to the utility port for establishing said pathway and for interfacing said utility resource therethrough.

2. The cladding system according to Embodiment 1, wherein the utility infrastructure is configured to be positioned at least partially in a gap between the framing structure and the wall of the building when the framing structure is mounted to the wall.

3. The cladding system according to Embodiment 1 or 2, wherein the at least one first cladding module is a planter module and the functional element is a plant.

4. The cladding system according to Embodiment 3, wherein the pathway constitutes an irrigation path for water hose, and the utility port is a water outlet.

5. The cladding system according to Embodiment 1 or 2, wherein the at least one first cladding module is a lighting panel and the functional element is an illuminating element.

6. The cladding system according to Embodiment 3, wherein the pathway constitutes a path for electrical connections, and the utility port is an electrical socket.

7. The cladding system according to any one of embodiments 1 to 6, wherein the framing structure comprises a utility socket and the utility port is connected to the utility socket.

8. The cladding system according to any one of embodiments 1 to 7, wherein the pathway comprises a plurality of utility ports, each corresponding to one or more of the designated locations.

9. The cladding system according to Embodiment 8, wherein each of the plurality of ports is configured to be accessed through a corresponding designated location.

10. The cladding system according to Embodiment 8 or 9, when dependent on Embodiment 7, wherein the framing structure comprises a plurality of utility sockets and at least one of the plurality of utility ports is connected to at least one of the plurality of utility sockets.

11. The cladding system according to any one of embodiments 8 to 10, wherein at least one of the plurality of utility ports is configured to be open while at least another of the plurality of utility ports is closed.

12. The cladding system according to any one of embodiments 1 to 11, wherein the utility infrastructure is at least partially integrated to the framing structure.

13. The cladding system according to any one of embodiments 1 to 12, wherein the framing structure comprises a plurality of struts configured to be assembled in the form of equally spaced rows and equally spaced columns, and to be fixedly mounted to the wall of the building.

14. The cladding system according to Embodiment 13, wherein spaces between the rows and the columns define the designated locations.

15. The cladding system according to Embodiment 14, wherein each of the designated locations is defined by a space between a first number of adjacent rows and a second number of adjacent columns.

16. The cladding system according to any one of embodiments 13 to 15, wherein the utility infrastructure is configured to pass through at least some of the plurality of struts when the framing structure is mounted to the wall.

17. The cladding system according to any one of embodiments 1 to 16, further comprising a mounting system configured for mounting the at least one first cladding module to the framing structure.

18. The cladding system according to Embodiment 17, wherein the mounting system comprises frame mounting sockets formed on the framing structure and connecting elements extending from the at least one cladding module and configured to be detachably connected to the frame mounting sockets.

19. The cladding system according to Embodiment 18, when dependent on Embodiment 13, wherein the frame mounting sockets are formed on the struts.

20. The cladding system according to Embodiment 19, wherein each of the struts comprise a plurality of frame mounting sockets, each configured for selectively detachably connecting the connecting elements thereto.

21. The cladding system according to any one of embodiments 18 to 20, wherein the mounting system further comprises module mounting sockets formed on the at least one first cladding module, wherein the connecting elements are configured to be detachably connected to the module mounting sockets.

22. The cladding system according to Embodiment 21, when dependent on Embodiment 13, wherein a distance between the module mounting sockets correspond to the distance between said columns and the sockets are arranged according to a predetermined pattern.

23. The cladding system according to any one of embodiments 1 to 22, further comprising at least one second cladding module, different from the first cladding module, configured to be mounted to the framing structure.

24. The cladding system according to Embodiment 23, when dependent on Embodiment 17, wherein the mounting system is configured for mounting the at least one second cladding module to the framing structure.

25. The cladding system according to Embodiment 24, wherein the mounting system is configured for enabling the first and the second cladding modules to be interchangeably mounted to the framing structure by the mounting system.

26. A cladding system comprising:
a framing structure comprising a plurality of struts configured to be assembled in the form of equally spaced rows and equally spaced columns, and to be fixedly mounted to a wall of a building;
at least one first cladding module configured to be mounted to the framing structure;
at least one second cladding module, different from the first cladding module, configured to be mounted to the framing structure; and
a mounting system configured for mounting each one of the first and the second cladding modules to the framing structure, wherein the mounting system is configured for enabling the first and the second cladding modules to be interchangeably mounted to the framing structure by the mounting system.

27. The cladding system according to Embodiment 26, wherein the mounting system comprises frame mounting sockets formed on the framing structure and connecting elements extending from one or more of the at least one first and second cladding modules and configured to be detachably connected to the frame mounting sockets.

28. The cladding system according to Embodiment 27, wherein the frame mounting sockets are formed on the struts.

29. The cladding system according to Embodiment 28, wherein each of the struts comprise a plurality of frame mounting sockets, each configured for selectively detachably connecting the connecting elements thereto.

30. The cladding system according to any one of embodiments 27 to 29, wherein the mounting system further comprises module mounting sockets formed on one or more of the at least one first and second cladding modules, wherein the connecting elements are configured to be detachably connected to the module mounting sockets.

31. The cladding system according to Embodiment 30, wherein a distance between the module mounting sockets correspond to the distance between said columns and the sockets are arranged according to a predetermined pattern.

32. The cladding system according to any one of embodiments 26 to 31, wherein said framing structure has one or more designated locations for mounting one or more of the first and the second cladding modules thereon.

33. The cladding system according to Embodiment 32, wherein spaces between the rows and the columns define the designated locations.

34. The cladding system according to Embodiment 33, wherein each of the designated locations is defined by a space between a first number of adjacent rows and a second number of adjacent columns.

35. The cladding system according to any of embodiments 26 to 34, further comprising a utility infrastructure configured to be connected to the framing structure and establish a pathway for a utility resource to be interfaced with the at least one first cladding module.

36. The cladding system according to Embodiment 35, wherein the utility infrastructure is configured to be positioned at least partially in a gap between the framing structure and the wall of the building when the framing structure is mounted to the wall.

37. The cladding system according to Embodiment 35 or 36, wherein the utility infrastructure is at least partially integrated to the framing structure.

38. The cladding system according to any one of embodiments 35 to 37, wherein the utility infrastructure is configured to pass through at least some of the plurality of struts when the framing structure is mounted to the wall.

39. The cladding system according to any one of embodiments 35 to 38, when dependent on Embodiment 32, wherein said pathway has a utility port for interfacing with the at least one first cladding module being disposed at one of said designated locations when said utility infrastructure is connected to said framing structure.

40. The cladding system according to Embodiment 39, wherein the at least one first cladding module comprises a functional element configured for connecting to the utility port for establishing said pathway and for interfacing said utility resource therethrough.

41. The cladding system according to Embodiment 40, wherein the at least one first cladding module is a planter module and the functional element is a plant.

42. The cladding system according to Embodiment 41, wherein the pathway constitutes an irrigation path for water hose, and the utility port is a water outlet.

43. The cladding system according to Embodiment 40, wherein the at least one first cladding module is a lighting panel and the functional element is an illuminating element.

44. The cladding system according to Embodiment 43, wherein the pathway constitutes a path for electrical connections, and the utility port is an electrical socket.

45. The cladding system according to any one of embodiments 39 to 44, wherein the framing structure comprises a utility socket and the utility port is connected to the utility socket.

46. The cladding system according to any one of embodiments 39 to 45, wherein the pathway comprises a plurality of utility ports, each corresponding to one or more of the designated locations.

47. The cladding system according to Embodiment 46, wherein each of the plurality of ports is configured to be accessed through a corresponding designated location.

48. The cladding system according to Embodiment 46 or 47, when dependent on Embodiment 45, wherein the framing structure comprises a plurality of utility sockets and at least one of the plurality of utility ports is connected to at least one of the plurality of utility sockets.

49. The cladding system according to any one of embodiments 46 to 48, wherein at least one of the plurality of utility ports is configured to be open while at least another of the plurality of utility ports is closed.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a schematic front view of a framing structure of a cladding system according to an example of the presently disclosed subject matter, the framing structure being configured for mounting to a wall of a building;

FIG. 1B is a schematic perspective view of another framing structure of the cladding system, the framing structure being configured for mounting to a roof of a building;

FIG. 1C is a schematic perspective view of cladding modules of the cladding system;

FIG. 2A is a schematic perspective view of a mounting system of the cladding system;

FIG. 2B is a schematic perspective view of a cladding module with corresponding parts of the mounting system;

FIG. 2C is a schematic perspective view of a mounting system configured for mounting one cladding module on to another cladding module according to an example of the presently disclosed subject matter;

FIG. 2D is a schematic perspective view of a mounting system configured for mounting one cladding module on to another cladding module according to another example of the presently disclosed subject matter;

FIG. 2E is a schematic side view of the cladding system with one of the cladding modules being a planter;

FIG. 2F is a schematic side view of the cladding system with one of the cladding modules being an awning element;

FIG. 3A is a schematic front view of a cladding system according to another example of the presently disclosed subject matter including a utility infrastructure;

FIG. 3B is a schematic side view of the cladding system of FIG. 3A;

FIG. 3C is a schematic side view of the cladding system of FIG. 3A with one cladding module being a planter;

FIG. 3D is a schematic side view of the cladding system of FIG. 3A with one cladding module being a lighting panel;

FIG. 4 is a schematic side view of the cladding system of FIG. 3A with one cladding module having an air path;

FIG. 5 is a schematic side view of the cladding system of FIG. 3A with one cladding module having a drain/ventilation element and one cladding module being an awning element;

FIG. 6 is a schematic perspective view of the cladding system of FIG. 3A with the utility infrastructure comprising MEP pathway;

FIG. 7 is a schematic side view of the cladding system of FIG. 3A with one cladding module being a solar panel;

FIG. 8 is a schematic side view of the cladding system of FIG. 3A with one cladding module having a gutter opening and the utility infrastructure comprising drainage pathway; and

FIG. 9 is a schematic side view of the cladding system of FIG. 3A with one cladding module configured for mounting a security camera thereto.

### DETAILED DESCRIPTION OF EMBODIMENTS

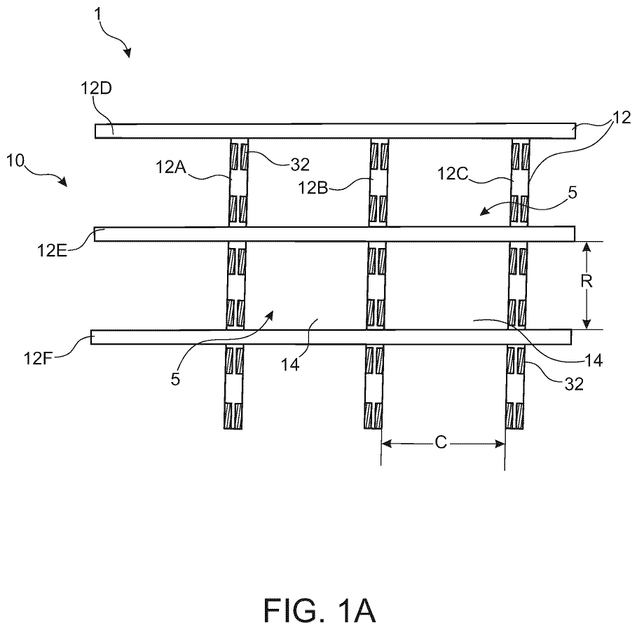

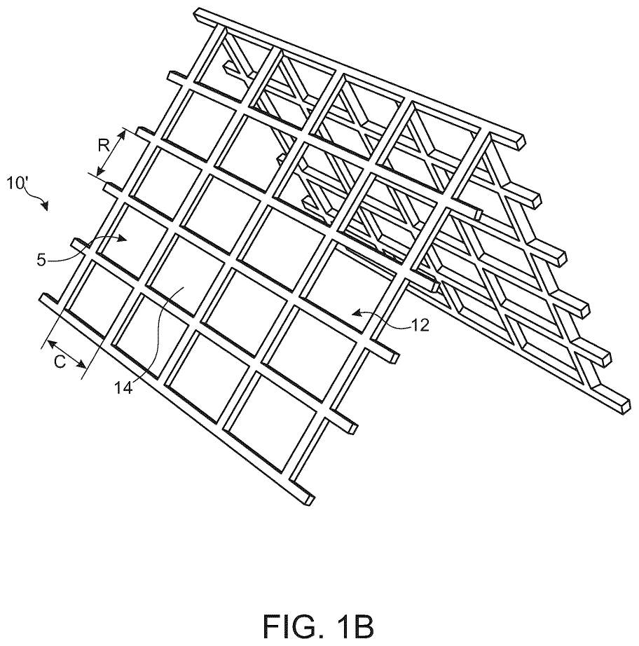

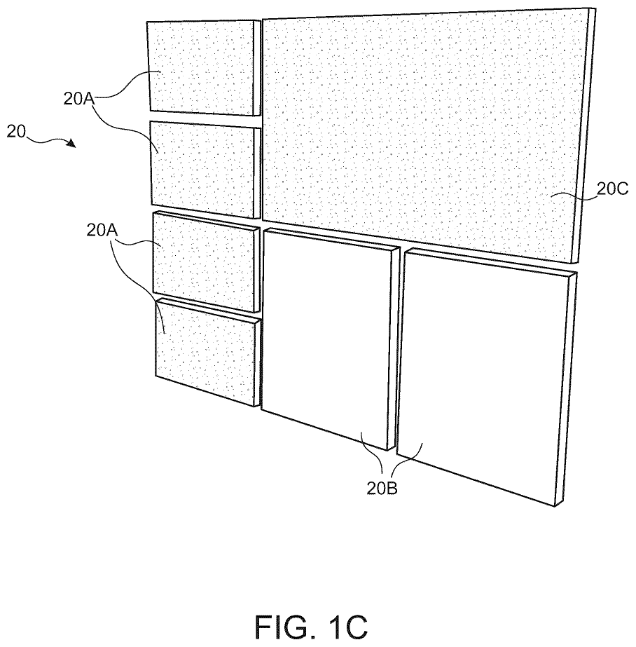

Reference is made to FIGS. 1A to 1C showing parts of a cladding system 1 in accordance with a non-limiting example of the presently disclosed subject matter. FIGS. 1A and 1B schematically illustrate framing structures 10 and 10′, each assembled from struts 12 positioned in the form of equally spaced rows and equally spaced columns. The framing structure 10 is configured for mounting to a wall of a building and the framing structure 10′ is configured for mounting to a roof of the building. In some examples, the framing structure can be configured to be mounted to any other landscape of the building such as, parking lot, lawn area, courtyard, interior wall, exterior wall, etc. Although the framing structure 10 has been described in detail herein, it is to be understood that the description applies analogously to framing structure 10′ as well.

The framing structure 10 is assembled from struts 12 with struts 12A, 12B, 12C positioned as equally spaced columns and struts 12D, 12E, 12F positioned as equally spaced rows. The struts can be connected to each other at at least some of the intersecting points. The distance C between two adjacent columns 12A and 12B is equal to the distance between other two adjacent columns 12B and 12C, and the distance R between two adjacent rows 12D and 12E is equal to the distance between other two adjacent rows 12E and 12F. In the illustrated example, the distance C is equal to distance R, however in other examples, C might not be equal to R depending on specific design and/or operational requirements. The spaces S between the struts 12 define designated locations 14 for mounting thereon cladding modules. A designated location 14 can be defined by a space S between two adjacent columns and two adjacent rows of struts, in one example. In another example, a designated location 14 can be defined by more than one space S, i.e., by spaces between any number of adjacent columns and any number of adjacent columns. In other words, a designated location 14 can be defined by a space having dimensions N*R by M*C, where M and N can be any integers.

FIG. 1C schematically illustrates cladding modules 20, each configured to be mounted to the framing structure 10 in a predetermined pattern by a mounting system, described further below. As can be seen in FIG. 1C, the cladding modules are differently sized and are configured to the framing structure forming a pattern, for example as illustrated. The cladding module 20A is configured to be mounted on a designated location 14 defined by a single space S, i.e., between two adjacent columns and two adjacent rows. The cladding module 20B is configured to be mounted on a designated location 14 defined by two spaces S, i.e., between two adjacent columns and three adjacent rows, or in other words by a space having dimensions 2R by 1C. The cladding module 20C is configured to be mounted on a designated location 14 defined by four spaces S, i.e., between three adjacent columns and three adjacent rows, or in other words by a space having dimensions 2R by 2C.

The cladding modules 20 can include one or more first type of cladding modules and/or one or more second type of cladding modules, herein referred to as first and second cladding modules, described in detail further below. Each of the cladding modules are configured to be mounted, in some examples detachably mounted, to the framing structure 10 by a mounting system.

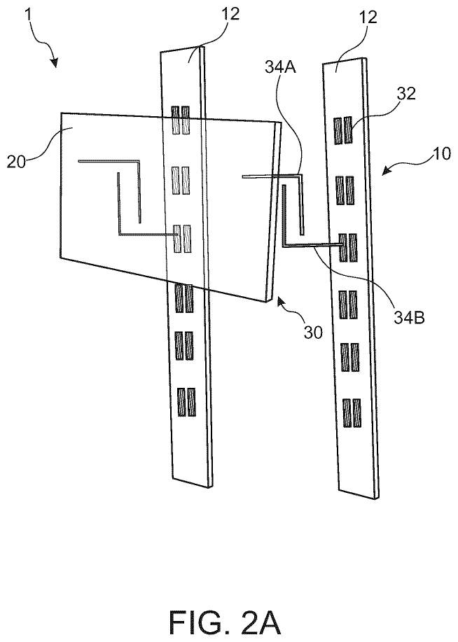

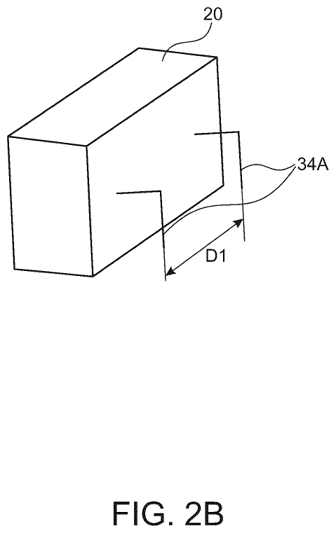

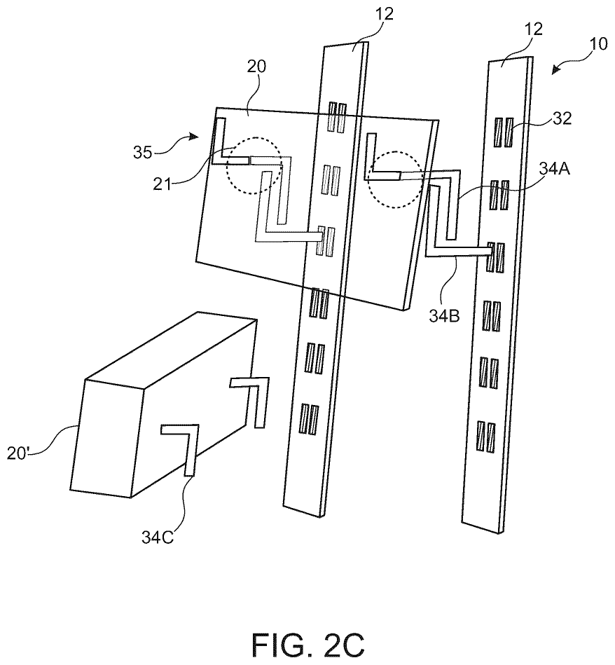

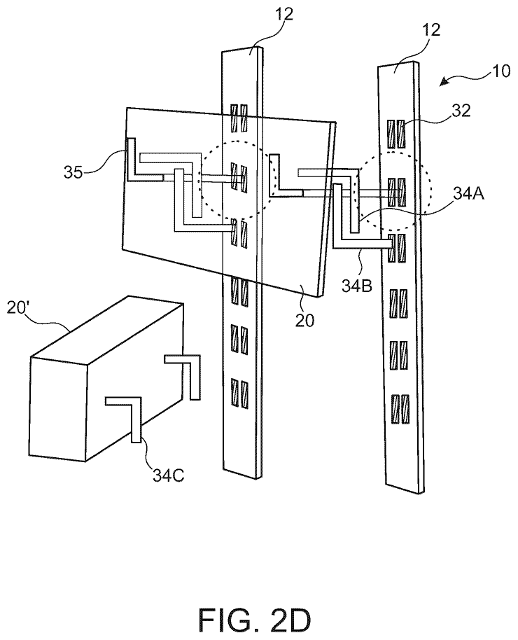

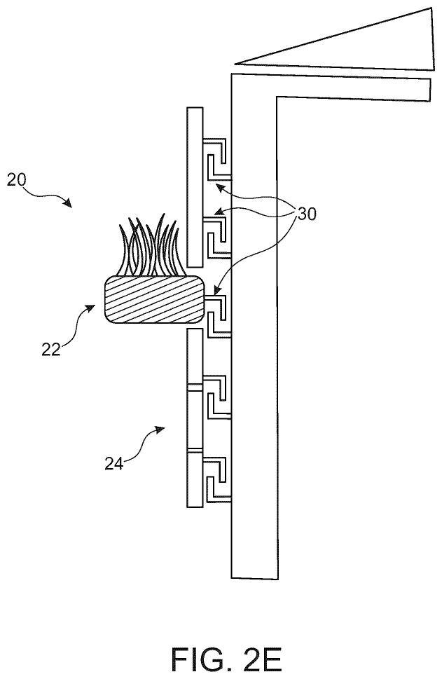

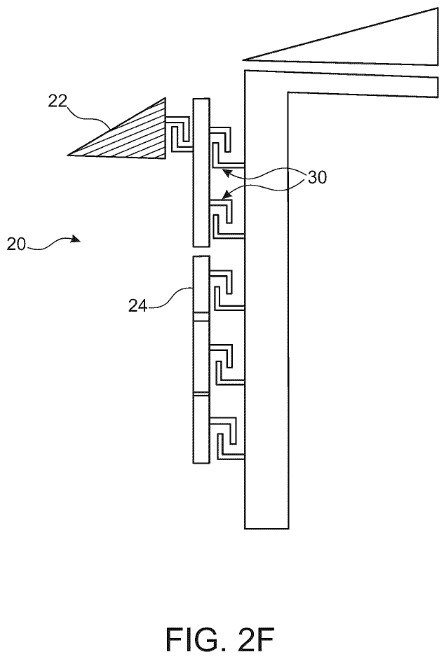

Reference is now made to FIGS. 2A to 2F showing parts of the cladding system 1, particularly a mounting system 30. The cladding modules 20 have been shown to be transparent in FIGS. 2A, 2C, and 2D to illustrate the parts of mounting system clearly. The mounting system 30 is configured for mounting one or more of the cladding modules 20 to the framing structure 10. In general, the mounting system 30 can include mounting sockets formed on the framing structure and/or the cladding modules and connecting elements configured to be detachably connected to the mounting sockets.

In the illustrated example, the mounting system 30 comprises frame mounting sockets 32 formed on the struts 12 of the framing structure 10. Although the frame mounting sockets 32 have been illustrated as being formed on the struts forming the columns, it is to be understood herein that the struts forming the rows can also (or alternatively) include the frame mounting sockets. Further, although the frame mounting sockets have not been shown on frame 10′ in FIG. 1B, it is to be understood herein that the frame 10′ also includes frame mounting sockets.

The mounting system 30 further includes connecting elements 34 configured to be detachably connected to the frame mounting sockets 32. In the illustrated example, each of the connecting elements 34 is constituted by two connecting elements 34A and 34B detachably connected to each other, whereas the connecting element 34A extends from the cladding module 20 and the connecting element 34B extends from the framing structure 10. In some examples, either or both of the connecting elements 34A and 34B can be fixedly connected to the cladding module 20 and framing structure 10 respectively. In some other examples, such as the illustrated examples, both of the connecting elements 34A and 34B are detachably connected to the cladding module 20 and framing structure 10 respectively. In the illustrated example, the cladding module 20 comprises module mounting sockets 36 for detachably connecting thereto the connecting elements 34A, and the connecting elements 34B can be detachably connected to the frame mounting sockets 32. The struts 12 of the framing structure 10 include a plurality of frame mounting sockets 32, and each of the frame mounting sockets 32 is configured to detachably receive and connect thereto the connecting element 34. Thus, any of the frame mounting sockets 32 can be used for mounting the cladding modules 20 according to a predetermined pattern depending on the desired orientation, design requirements, and size of the cladding module. In the illustrated example, the frame mounting sockets 32 have been shown as being formed on the struts constituting the columns of the framing structure, it is to be understood herein that the mounting sockets can also (or alternatively) be formed on the struts constituting the rows. Also, as can be seen in the illustrated example, the distance D1 between the module mounting sockets 36 correspond to the distance C between the columns of the framing structure. If the frame mounting sockets are formed on the rows, the distance between the corresponding module mounting sockets correspond the distance R between the rows. Thus, the cladding modules can be arranged on the framing structure in any predetermined pattern, for example as described with respect to FIG. 1C.

In the illustrated example, the connecting elements 34 are L-shaped brackets extending from the cladding module as well as the framing structure and detachably articulated to each other. In other examples, the connecting elements can have any other shape as desired for the design requirements and/or as most suitable for the building landscape.

In the illustrated example, for instance as shown in FIGS. 2C and 2D, the mounting system 30 comprises auxiliary connecting elements 35 extending from a front side of the cladding module 20 for mounting on the cladding module 20 another cladding module. As can be seen in FIGS. 2C, 2D, and 2F, a cladding module 20′ is mounted onto another cladding module 20. The cladding module 20′ can be a first type of cladding module and the cladding module 20 can be a second type of cladding module. The cladding module 20′ has connecting elements 34C extending from a back side thereof and configured for detachably connecting to the auxiliary connecting elements 35 of the cladding module 20. In the example illustrated in FIG. 2C, the auxiliary connecting elements 35 are formed in continuation with the connecting elements 34B that extend through the cladding module 20 at portions 21 shown in dotted circles. In the example illustrated in FIG. 2D, the auxiliary connecting elements 35 are formed as separate elements that extend through the cladding module 20 and connected to the mounting sockets 32 (shown in dotted circles) of the framing structure 10.

The cladding modules 20 include one or more first cladding modules 22 having a functional element. In other words, the first cladding module is a utility module that has at least one operational/functional element. The cladding module 20 further includes one or more second cladding modules 24 different from the first cladding modules 22. The second cladding modules can be rain-screening tiles, wall/roof tiles, or any other type of non-functional cladding modules. The mounting system 30 and the first and the second cladding modules 22 and 24 are configured such that the first and the second cladding modules 22 and 24 can be mounted to the framing structure in an interchangeable manner. For instance, any of the first and the second cladding module 22 and 24 can be mounted to any designated location of the framing structure using the same mounting system 30.

In the example illustrated in FIG. 2E, the first cladding module 22 is a planter module and the functional element is a plant, and the second cladding module 24 is a normal rain-screening tile. As can be seen in FIG. 2E, the mounting system 30 (particularly the connecting elements 34) are configured for enabling the first and the second cladding modules 22 and 24 to be interchangeably mounted to the framing structure 10 by the mounting system 30. For instance, the connecting elements 34A associated with the cladding modules 22 and 24 can be detachably connected to any of the connecting elements 34B associated with the framing structure 10. The connecting elements 34A can be detached from the connecting 34B and can be connected to any other of the connecting elements 34B.

In the example illustrated in FIG. 2F, the first cladding module 22 is an awning element and the second cladding module 24 is a normal rain-screening tile. As can be seen in FIG. 2E, the first cladding module 22 is mounted onto the second cladding module 24. The first cladding module 22 can be mounted directly to the framing structure 10 by the mounting system 30, in a manner as detailed herein above.

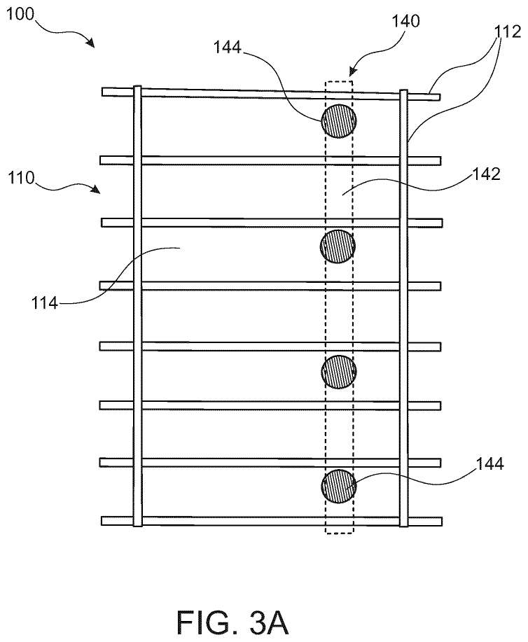

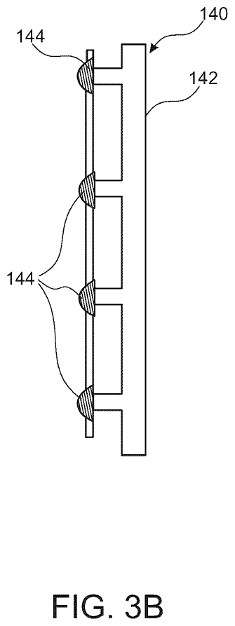

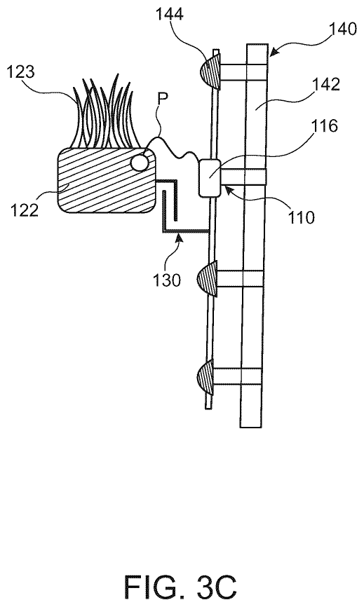

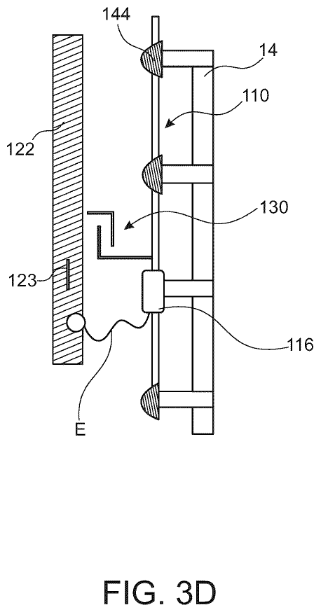

Attention is now drawn to FIGS. 3A to 3D showing parts of a cladding system 100 according to another example of the presently disclosed subject matter. The parts of the cladding system 100 that are corresponding to the parts of the cladding system 1 have been referenced by corresponding reference numerals. For instance, the cladding system 100 includes a framing structure 110 formed by struts 112. The framing structure 110 can be similar in function and structure to the framing structure 10, i.e., having the same features corresponding to the spaces between the columns and rows, designated locations, etc., or can have a different structure than that of the framing structure 10. For instance, in the illustrated example, the distance between the columns of the framing structure 110 are not equal to the distance between the rows thereof. The framing structure 110 includes designated locations 114 for mounting of cladding modules thereon.

The cladding system 100 comprises one or more first cladding modules 122 configured to be mounted on the framing structure at any of the designated locations 114. The first cladding module 122 includes a functional element which is associated with at least one operational requirement of the building.

The cladding system 100 further comprises a utility infrastructure 140 configured to be connected to the framing structure 110 and/or constituting at least a part of the framing structure 110. The utility infrastructure 140 establishes a pathway 142 for a utility resource to be interfaced therethrough. The pathway 142 has a plurality of utility ports 144, each configured for =interfacing with the first cladding module 122 mounted at any of the designated locations 114. In other words, each of the utility ports 144 is accessible through one or more of the designated locations 114 and establish an interface of the first cladding module 122 mounted on any one of the designated locations 114 with the pathway 142.

In the illustrated example, the pathway 142 has a plurality of utility ports 144 each corresponding to one designated location 114, however, in other examples, the path 142 can have one utility port 144 corresponding to more than one designated locations 114. The utility infrastructure 140 is configured to be positioned at least partially in a gap between the framing structure and the wall (or any other landscape on which the framing structure is mounted) of the building when the framing structure is mounted thereto. In some examples, the utility infrastructure 140 is configured to pass through the struts 112 of the framing structure 110.

The framing structure 110 has a utility socket 116 and one of the utility ports 144 is connected to the utility socket 116. The utility resource can be communicated between the first cladding module 122 and the utility port 144 via the utility socket 116. In some examples, the framing structure 110 can have a plurality of utility sockets 116 and at least one of the utility ports 144 is connected to at least one of the utility sockets 116. Also, the utility ports 144 are configured to be used whenever required and be selectively closed when not in use. For instance, out of the plurality of utility ports 144, one or more of them can be opened for use and others can remain closed at the same time.

In the example illustrated in FIG. 3C, the first cladding module 122 is a planter module having the functional element 123, which is a plant. The planter module 122 is mounted to the framing structure 110 and is in communication with the pathway 142 of the utility infrastructure 140 via the utility socket 116, which is connected to a utility port (not visible). The functional element plant 123 requires a regular supply of utility resource, which in this case is water for its function to be performed, and thus the utility port to which the utility socket 116 is connected to is a water outlet. The utility resource is provided to the functional element via a water hose pipe connected to the utility socket 116. The utility infrastructure 140 establishes the pathway 142 for the water to be communicated (interfaced) from a water supply source to the plant in the planter module, for example plumbing systems. As can be seen in FIG. 3C, the planter module 122 can be mounted to any designated location on the framing structure and a corresponding one of the utility ports 144 can be used for providing the water therethrough to the plant while all other utility ports 144 can remain closed.

In the example illustrated in FIG. 3D, the first cladding module 122 is a lighting panel having the functional element 123, which is an illuminating element. In this example, the functional element 123 requires a supply of utility resource, which in this case is electricity for its function to be performed, and thus the utility port to which the utility socket 116 is connected to is an electrical socket. The utility resource is provided to the functional element via electrical connections E connected to the utility socket 116. The utility infrastructure 140 establishes the pathway 142 for the electrical connections to be communicated from an electricity supply source to the illuminating element in the lighting panel. As can be seen in FIG. 3D, the lighting panel 122 can be mounted to any designated location on the framing structure and a corresponding one of the utility ports 144 can be used for providing the electricity therethrough to the illuminating element while all other utility ports 144 can remain closed.

As can be seen in FIGS. 3C and 3D, more than one first cladding modules 122 (of same or different types) can be mounted to the framing structure 10 and the pathway 142 can be used to transport the relevant utility resource to/from the first cladding module 122 via a corresponding utility socket 116 and/or utility port 144 and the pathway 142.

The cladding system 100 further includes a mounting system 130 for mounting the first cladding module 122 to the framing structure 110. In some examples, the cladding system 100 can also have one or more second cladding modules, corresponding to the second cladding modules 24 of the cladding system 1. The mounting system 130 has the same structure and operates in the same manner as the mounting system 30, and the first cladding modules 122 and the second cladding modules can be interchangeably mounted to the framing structure 110 by the mounting system 130 in the same manner as described above for the first and second cladding modules 22 and 24 and the mounting system 30.

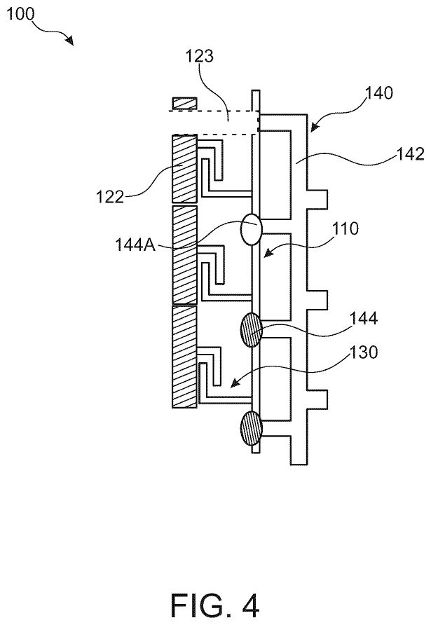

Attention is drawn to FIGS. 4 to 9 showing some exemplary different applications of the cladding system 110, each of these figures showing one or more different types of first cladding modules 122 with one or more of other features being same as described above.

In the example illustrated in FIG. 4, the first cladding module 122 is an air exhaust module comprising the functional element 123, which is an air path connected to the pathway 142, which establishes the communication between the air path 123 and one or more locations within the building. As can be seen in FIG. 4, the other cladding modules are the second cladding modules 24 which can be normal rain screening tiles. Also, one of the utility ports 144A corresponding to the designated location on which the first cladding module 122 is mounted, is open while all other utility ports 144 are closed.

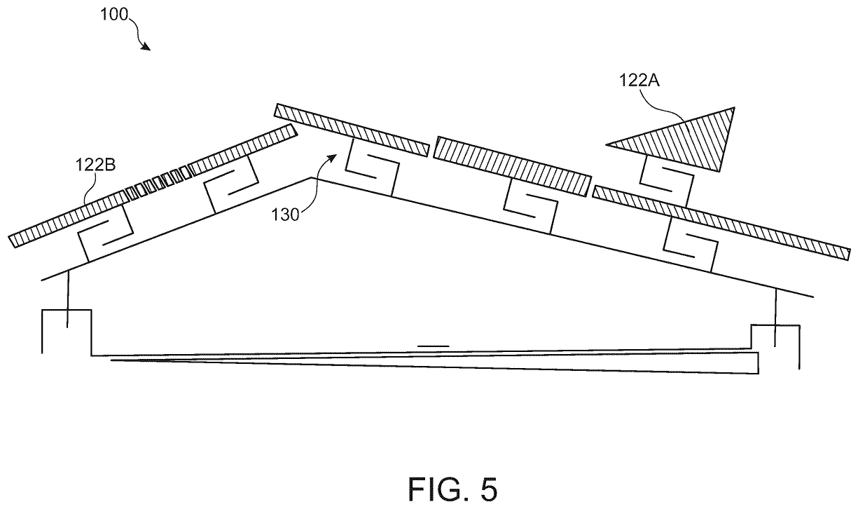

In the example illustrated in FIG. 5, one of the first cladding modules 122 is an awning element 122A and another one of the first cladding modules 122 is a drain/ventilation element 122B. The drain/ventilation element 122B provides a communication of fresh air to one or more locations inside the building or transports drain water to a drainage sink.

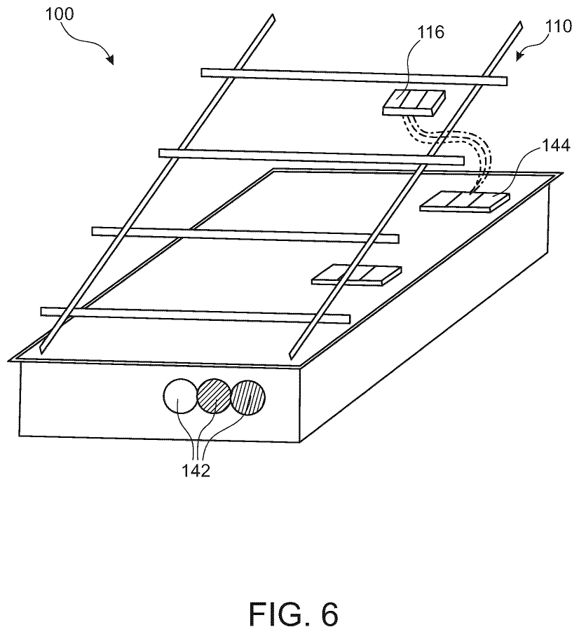

In the example illustrated in FIG. 6, the utility infrastructure 140 includes a combined muti-functional MEP (mechanical, electrical and plumbing) pathway 142. The first cladding modules (not shown) can be multiple types of the first cladding modules utilizing on or more utility resources being provided through the MEP pathway 142 via multiple MEP utility ports 144 and the utility sockets 116.

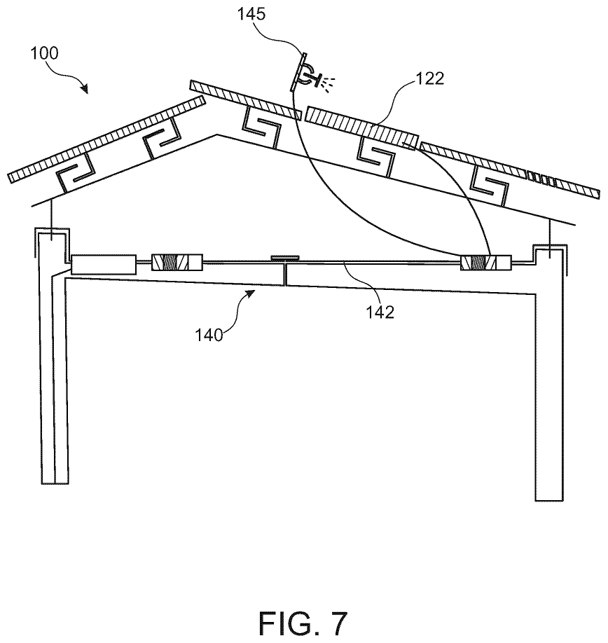

In the example illustrated in FIG. 7, the first cladding module 122 is a solar panel and the utility infrastructure 140 comprises a water washer element 145 for washing the solar panel. The water washer element 145 being connected to a water supply source via the pathway 142. In FIG. 7, there is illustrated another first cladding module which is a drain/ventilation element same as the one depicted in FIG. 5.

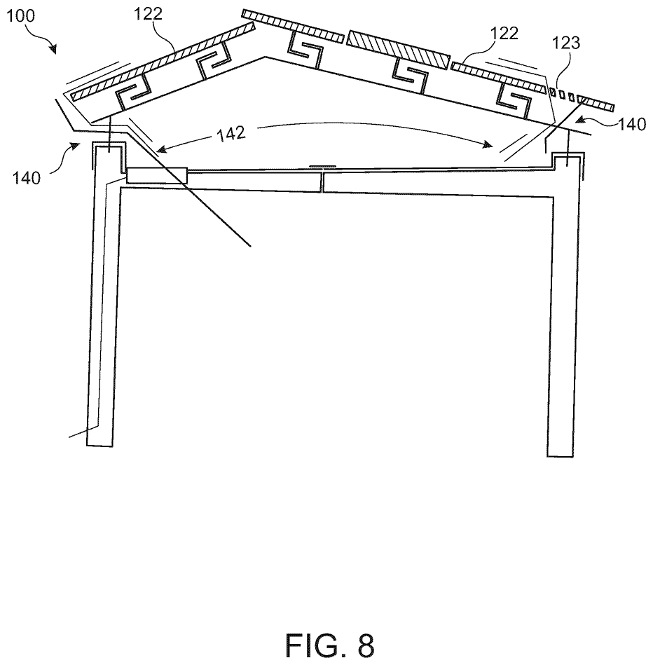

In the example illustrated in FIG. 8, the utility infrastructure 140 includes a drainage pathway 142 communicating drain water from the first cladding module 122 having a gutter opening to a drain sink therethrough. first cladding module 122. In FIG. 7, there is illustrated another first cladding module which is a drain/ventilation element same as the one depicted in FIG. 5.

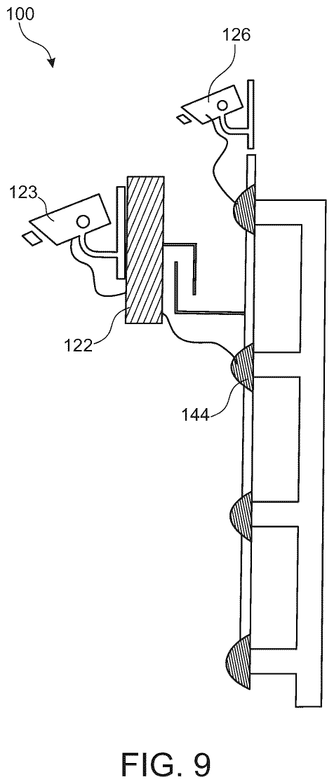

In the example illustrated in FIG. 9, the first cladding module 122 is configured for mounting thereon a security camera 123 (constituting the functional element), which has been provided the connections via a utility port 144. Illustrated herein is another security camera 126 which is mounted directly to the wall of the building and has been provided the connections via another utility port 144.

It is to be understood herein that the above-described examples and/or applications of the cladding systems 1 and 100 are exemplary and the cladding systems 1 and/or 100 can be mounted to other landscapes of the building such as parking lot, lawn, courtyard, etc. and the first cladding modules can have other functional elements corresponding to the landscape.

1. A cladding system comprising:
a framing structure configured to be fixedly mounted to a wall of a building, said framing structure having one or more designated locations for mounting a cladding module thereon;
a utility infrastructure configured to be connected to the framing structure and establish a pathway for a utility resource, said pathway having a utility port for interfacing with a cladding module being disposed at one of said designated locations when said utility infrastructure is connected to said framing structure; and
at least one first cladding module having a functional element, said at least one first cladding module being configured to be mounted to the framing structure at any one of said designated locations, said functional element being configured for connecting to the utility port for establishing said pathway and for interfacing with said utility resource therethrough.

2. The cladding system according to claim 1, wherein the utility infrastructure is configured to be positioned at least partially in a gap between the framing structure and the wall of the building when the framing structure is mounted to the wall.

3. The cladding system according to claim 1 or 2, wherein the at least one first cladding module is a planter module and the functional element is a plant.

4. The cladding system according to claim 3, wherein the pathway constitutes an irrigation path for water hose, and the utility port is a water outlet.

5. The cladding system according to claim 1 or 2, wherein the at least one first cladding module is a lighting panel and the functional element is an illuminating element.

6. The cladding system according to claim 3, wherein the pathway constitutes a path for electrical connections, and the utility port is an electrical socket.

7. The cladding system according to any one of claims 1 to 6, wherein the framing structure comprises a utility socket and the utility port is connected to the utility socket.

8. The cladding system according to any one of claims 1 to 7, wherein the pathway comprises a plurality of utility ports, each corresponding to one or more of the designated locations.

9. The cladding system according to claim 8, wherein each of the plurality of ports is configured to be accessed through a corresponding designated location of the one or more designated locations.

10. The cladding system according to claim 8 or 9, when dependent on claim 7, wherein the framing structure comprises a plurality of utility sockets and at least one of the plurality of utility ports is connected to at least one of the plurality of utility sockets.

11. The cladding system according to any one of claims 8 to 10, wherein at least one of the plurality of utility ports is configured to be open while at least another of the plurality of utility ports is closed.

12. The cladding system according to any one of claims 1 to 11, wherein the utility infrastructure is at least partially integrated to the framing structure.

13. The cladding system according to any one of claims 1 to 12, wherein the framing structure comprises a plurality of struts configured to be assembled in the form of equally spaced rows and equally spaced columns, and to be fixedly mounted to the wall of the building.

14. The cladding system according to claim 13, wherein spaces between the rows and the columns define the designated locations.

15. The cladding system according to claim 14, wherein each of the designated locations is defined by a space between a first number of adjacent rows and a second number of adjacent columns.

16. The cladding system according to any one of claims 13 to 15, wherein the utility infrastructure is configured to pass through at least some of the plurality of struts when the framing structure is mounted to the wall.

17. The cladding system according to any one of claims 1 to 16, further comprising a mounting system configured for mounting the at least one first cladding module to the framing structure.

18. The cladding system according to claim 17, wherein the mounting system comprises frame mounting sockets formed on the framing structure and connecting elements extending from the at least one cladding module and configured to be detachably connected to the frame mounting sockets.

19. The cladding system according to claim 18, when dependent on claim 13, wherein the frame mounting sockets are formed on the struts.

20. The cladding system according to claim 19, wherein each of the struts comprise a plurality of frame mounting sockets, each configured for selectively detachably connecting the connecting elements thereto.

21. The cladding system according to any one of claims 18 to 20, wherein the mounting system further comprises module mounting sockets formed on the at least one first cladding module, wherein the connecting elements are configured to be detachably connected to the module mounting sockets.

22. The cladding system according to claim 21, when dependent on claim 13, wherein a distance between the module mounting sockets correspond to the distance between said columns and the sockets are arranged according to a predetermined pattern.

23. The cladding system according to any one of claims 1 to 22, further comprising at least one second cladding module, different from the first cladding module, configured to be mounted to the framing structure.

24. The cladding system according to claim 23, when dependent on claim 17, wherein the mounting system is configured for mounting the at least one second cladding module to the framing structure.

25. The cladding system according to claim 24, wherein the mounting system is configured for enabling the first and the second cladding modules to be interchangeably mounted to the framing structure by the mounting system.

26. A cladding system comprising:
a framing structure comprising a plurality of struts configured to be assembled in the form of equally spaced rows and equally spaced columns, and to be fixedly mounted to a wall of a building;
at least one first cladding module configured to be mounted to the framing structure;
at least one second cladding module, different from the first cladding module, configured to be mounted to the framing structure; and
a mounting system configured for mounting each one of the first and the second cladding modules to the framing structure, wherein the mounting system is configured for enabling the first and the second cladding modules to be interchangeably mounted to the framing structure by the mounting system.

27. The cladding system according to claim 26, wherein the mounting system comprises frame mounting sockets formed on the framing structure and connecting elements extending from one or more of the at least one first and second cladding modules and configured to be detachably connected to the frame mounting sockets.

28. The cladding system according to claim 27, wherein the frame mounting sockets are formed on the struts.

29. The cladding system according to claim 28, wherein each of the struts comprise a plurality of frame mounting sockets, each configured for selectively detachably connecting the connecting elements thereto.

30. The cladding system according to any one of claims 27 to 29, wherein the mounting system further comprises module mounting sockets formed on one or more of the at least one first and second cladding modules, wherein the connecting elements are configured to be detachably connected to the module mounting sockets.

31. The cladding system according to claim 30, wherein a distance between the module mounting sockets correspond to the distance between said columns and the sockets are arranged according to a predetermined pattern.

32. The cladding system according to any one of claims 26 to 31, wherein said framing structure has one or more designated locations for mounting one or more of the first and the second cladding modules thereon.

33. The cladding system according to claim 32, wherein spaces between the rows and the columns define the designated locations.

34. The cladding system according to claim 33, wherein each of the designated locations is defined by a space between a first number of adjacent rows and a second number of adjacent columns.

35. The cladding system according to any of claims 26 to 34, further comprising a utility infrastructure configured to be connected to the framing structure and establish a pathway for a utility resource to be interfaced with the at least one first cladding module.

36. The cladding system according to claim 35, wherein the utility infrastructure is configured to be positioned at least partially in a gap between the framing structure and the wall of the building when the framing structure is mounted to the wall.

37. The cladding system according to claim 35 or 36, wherein the utility infrastructure is at least partially integrated to the framing structure.

38. The cladding system according to any one of claims 35 to 37, wherein the utility infrastructure is configured to pass through at least some of the plurality of struts when the framing structure is mounted to the wall.

39. The cladding system according to any one of claims 35 to 38, when dependent on claim 32, wherein said pathway has a utility port for interfacing with the at least one first cladding module being disposed at one of said designated locations when said utility infrastructure is connected to said framing structure.

40. The cladding system according to claim 39, wherein the at least one first cladding module comprises a functional element configured for connecting to the utility port for establishing said pathway and for interfacing with said utility resource therethrough.

41. The cladding system according to claim 40, wherein the at least one first cladding module is a planter module and the functional element is a plant.

42. The cladding system according to claim 41, wherein the pathway constitutes an irrigation path for water hose, and the utility port is a water outlet.

43. The cladding system according to claim 40, wherein the at least one first cladding module is a lighting panel and the functional element is an illuminating element.

44. The cladding system according to claim 43, wherein the pathway constitutes a path for electrical connections, and the utility port is an electrical socket.

45. The cladding system according to any one of claims 39 to 44, wherein the framing structure comprises a utility socket and the utility port is connected to the utility socket.

46. The cladding system according to any one of claims 39 to 45, wherein the pathway comprises a plurality of utility ports, each corresponding to one or more of the designated locations.

47. The cladding system according to claim 46, wherein each of the plurality of ports is configured to be accessed through a corresponding designated location.

48. The cladding system according to claim 46 or 47, when dependent on claim 45, wherein the framing structure comprises a plurality of utility sockets and at least one of the plurality of utility ports is connected to at least one of the plurality of utility sockets.

49. The cladding system according to any one of claims 46 to 48, wherein at least one of the plurality of utility ports is configured to be open while at least another of the plurality of utility ports is closed.
